(19) United States
(12) Patent Application Publication
(10) Pub. No.: US 2024/0125433 A1
(43) Pub. Date: Apr. 18, 2024

(54) MONITORING SYSTEM AND METHOD OF HYDROGEN REFUELING STATION AND COMPUTING DEVICE FOR EXECUTING THE SAME

(71) Applicant: AJOU UNIVERSITY INDUSTRY-ACADEMIC COOPERATION FOUNDATION, Suwon-si (KR)

(72) Inventors: Bong Sik OH, Suwon-si (KR); Joong-Soon JANG, Yongin-si (KR); SangChul PARK, Yongin-si (KR)

(73) Assignee: AJOU UNIVERSITY INDUSTRY-ACADEMIC COOPERATION FOUNDATION, Suwon-si (KR)

(21) Appl. No.: 18/486,506

(22) Filed: Oct. 13, 2023

(30) Foreign Application Priority Data
Oct. 14, 2022 (KR) 10-2022-0132600

(51) Int. Cl. F17C 13/02

(52) U.S. Cl. CPC F17C 13/02; F17C 2221/012; F17C 2250/032; F17C 2250/0694; F17C 2265/065

(57) ABSTRACT

There are disclosed a monitoring system and method for a hydrogen refueling station and a computing device for executing the same. The monitoring system for a hydrogen refueling station according to one embodiment of the present disclosure includes an Internet of things (IoT) sensor mounted on each of components of the hydrogen refueling station and configured to generate sensing data by measuring preset monitoring elements and an analysis server configured to obtain the sensing data and monitor a state of the hydrogen refueling station based on the obtained sensing data.

### CROSS-REFERENCE TO RELATED APPLICATION(S)

This application claims the benefit under 35 USC § 119(a) of Korean Patent Application No. 10-2022-0132600, filed on Oct. 14, 2022, in the Korean Intellectual Property Office, the entire disclosure of which is incorporated herein by reference for all purposes.

### BACKGROUND

### 1. Field

Embodiments of the present disclosure relate to a technology for monitoring a hydrogen refueling station.

### 2. Description of Related Art

As an eco-friendly future energy source, Hydrogen energy is known to be a key driving force in the economy and industry. In order to establish a hydrogen economy, construction of hydrogen refueling stations has to be prioritized, but the construction of hydrogen refueling stations is slowly progressing due to the budget requirement of billions of won for building one hydrogen refueling station and residents' anxiety about the dangers of hydrogen.

Since a large amount of hydrogen gas is dealt with at the hydrogen refueling station, leakage of hydrogen gas during processing and transportation of the hydrogen gas poses a risk of an accident leading to a fire or explosion when an ignition source exists nearby, and thus ensuring the safety of the hydrogen refueling station is a very important factor.

Examples of the related art include Korean Patent Registration No. 10-2347800 (Jan. 6, 2022).

### SUMMARY

The disclosed embodiments are intended to provide a monitoring system and method for a hydrogen refueling station capable of monitoring a state of the hydrogen refueling station, and a computing device for executing the same.

In one general aspect, there is provided a monitoring system for a hydrogen refueling station including an Internet of things (IoT) sensor mounted on each of components of the hydrogen refueling station and configured to generate sensing data by measuring preset monitoring elements and an analysis server configured to obtain the sensing data and monitor a state of the hydrogen refueling station based on the obtained sensing data.

The IoT sensor may operate in a measurement mode for a preset time in a preset period and operate in a sleep mode at other times.

The sensing data may include identification information and measured values for the monitoring elements regarding a component of the hydrogen refueling station on which a corresponding IoT sensor is mounted.

The analysis server may calculate a risk degree for each of the components of the hydrogen refueling station based on the identification information and the measured values for the monitoring elements regarding the component of the hydrogen refueling station.

The analysis server may assign a risk score according to the number of times a measured value for each of the monitoring elements exceeds a preset reference value for each of the components.

The analysis server may assign a first weight depending on a pre-stored frequency of accident occurrence and assign a second weight depending on a pre-stored degree of failure impact, for each of the components.

The analysis server may assign a higher first weight as the frequency of accident occurrence is higher and assign a higher second weight as the degree of failure impact is higher.

The analysis server may calculate the risk degree for each of the components according to the following equation based on the risk score, the first weight, and the second weight,

(Equation)

Risk level=(α+β)·Score

where α is the first weight,

β is the second weight, and

Score is the risk score.

The analysis server may calculate safety reliability of the hydrogen refueling station by taking an inverse of a value obtained by adding up the risk degree for each of the components of the hydrogen refueling station and then dividing an added result by the number of the components of the hydrogen refueling station.

In another general aspect, there is provided a monitoring method for a hydrogen refueling station that is performed in a computing device including one or more processors and a memory storing one or more programs executed by the one or more processors, the monitoring method including obtaining sensing data from an IoT sensor mounted on each of components of the hydrogen refueling station and configured to generate the sensing data by measuring preset monitoring elements and monitoring a state of the hydrogen refueling station based on the obtained sensing data.

In still another general aspect, there is provided a computing device including one or more processors, a memory, and one or more programs, in which the one or more programs are configured to be stored in the memory and executed by the one or more processors, and the one or more programs include a command for obtaining sensing data from an IoT sensor mounted on each of components of the hydrogen refueling station and configured to generate the sensing data by measuring preset monitoring elements and a command for monitoring a state of the hydrogen refueling station based on the obtained sensing data.

### BRIEF DESCRIPTION OF THE DRAWINGS

FIG. 1 is a block diagram showing a configuration of a monitoring system for a hydrogen refueling station according to one embodiment of the present disclosure.

FIG. 2 is a diagram schematically showing components of a hydrogen refueling station according to one embodiment of the present disclosure.

FIG. 3 is a block diagram showing a configuration of an analysis server according to one embodiment of the present disclosure.

FIG. 4 is a flowchart illustrating a monitoring method for a hydrogen refueling station according to one embodiment of the present disclosure.

FIG. 5 is a block diagram exemplarily illustrating a computing environment that includes a computing device suitable for use in exemplary embodiments.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

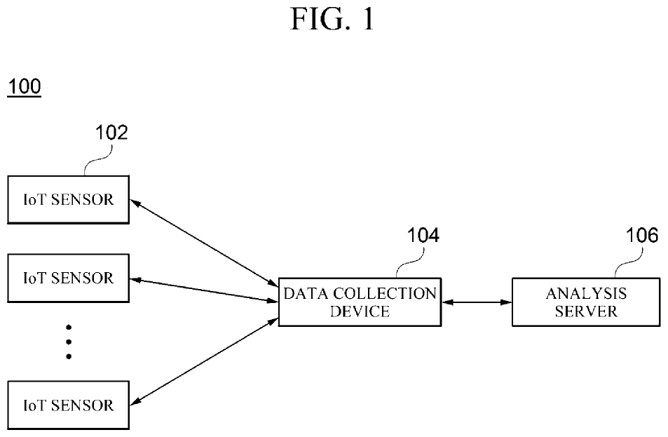

FIG. 1 is a block diagram showing a configuration of a monitoring system for a hydrogen refueling station according to one embodiment of the present disclosure.

Referring to FIG. 1, the monitoring system for a hydrogen refueling station (hydrogen refueling station monitoring system) 100 may include Internet of Things (IoT) sensors 102, a data collection device 104, and an analysis server 106.

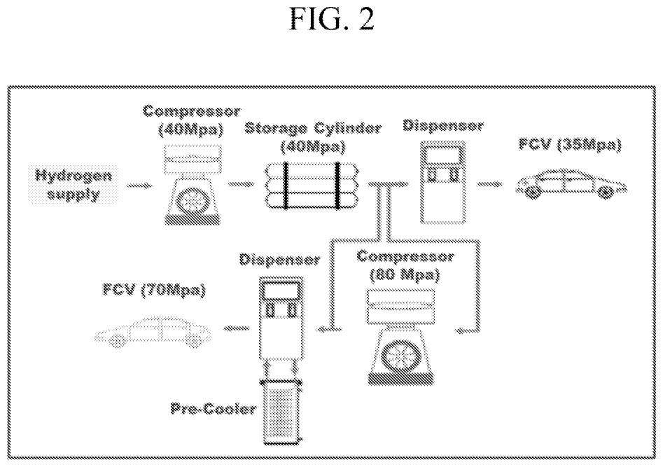

The IoT sensor 102 may be mounted on each of the components of the hydrogen refueling station. Here, as shown in FIG. 2, the hydrogen refueling station may basically include a storage tank for storing hydrogen, a compressor for increasing the pressure of hydrogen, and a dispenser for charging hydrogen into a vehicle. In this case, an off-site hydrogen refueling station supplies hydrogen gas generated at an external plant through a tube trailer or hydrogen piping. In addition, the hydrogen refueling station may include various filters and valves, and may include a cooler for cooling hydrogen gas.

The IoT sensor 102 may be mounted on each of the components of the hydrogen refueling station (the storage tank, the compressor, the dispenser, a tube trailer, a cooler, a filter, a valve, or the like) to measure (sense) preset monitoring elements. Here, monitoring elements may include temperature, humidity, pressure, vibration, fine dust, sulfur oxide gas, gas leakage, base, a charging rate, a charge amount, a charging time, and the like. The IoT sensor 102 may be provided to operate with its own power source (e.g., battery). In this case, the IoT sensor 102 may be provided to operate at low power.

For example, the IoT sensor 102 may operate only for a preset time (e.g., three seconds) in a preset period (e.g., one hour period) to measure the monitoring elements and transmit measured values (that is, sensing data) to the data collection device 104. In this case, the IoT sensor 102 may be activated only for the preset time in the preset period and operate in a measurement mode, and may be deactivated at other times and operate in a sleep mode.

That is, the IoT sensor 102 may be provided to measure monitoring elements for a long period of time without dispatching an administrator after being installed in a site through a low-power design. The sensing data may include identification information regarding a component of the hydrogen refueling station where a corresponding IoT sensor 102 is mounted.

The data collection device 104 is communicatively connected to the IoT sensors 102 and the analysis server 106 through a communication network. Here, the communication network may include the Internet, one or more local area networks, wide area networks, cellular networks, mobile networks, other types of networks, or a combination of the above-mentioned networks.

The data collection device 104 may collect sensing data from a plurality of IoT sensors 102 mounted on the respective components of the hydrogen refueling station. The data collection device 104 may be installed at each hydrogen refueling station. The data collection device 104 may collect sensing data from the plurality of IoT sensors 102 installed at the corresponding hydrogen refueling station.

The data collection device 104 may collect sensing data from each IoT sensor 102 in a preset period, but is not limited to thereto. The data collection device 104 may transmit sensing data from the plurality of IoT sensors 102 to the analysis server 106.

The analysis server 106 may assess states of the hydrogen refueling station and each of the components of the hydrogen refueling station based on the sensing data received from the data collection device 104. In an exemplary embodiment, the analysis server 106 may perform a risk degree assessment of each of the components of the hydrogen refueling station based on the sensing data received from the data collection device 104 and perform prognostics and health management (PHM) according to results of the risk degree assessment.

Specifically, the analysis server 106 may calculate a risk degree for each of the components of each hydrogen refueling station based on the identification information and the measured values regarding the components of the hydrogen refueling station included in the sensing data. The analysis server 106 may calculate the risk degree for each of the components of each hydrogen refueling station using sensing data collected for a preset period.

The analysis server 106 may assign a risk score according to the number of times the measured value for each of the monitoring elements exceeds a preset reference value for each of the components of each hydrogen refueling station. For example, when the component is the compressor, the monitoring elements may be temperature, pressure, and the like, and the risk score may be assigned to the compressor according to the number of times the measured values for temperature and pressure exceed preset reference values.

In this case, the analysis server 106 may assign weights depending on a frequency of accident occurrence and a degree of failure impact in the past for each of the components of the hydrogen refueling station. That is, the analysis server 106 may check an accident history for each of the components of the hydrogen refueling station and pre-store information on the frequency of accident occurrence. The analysis server 106 may assign a first weight depending on the frequency of accident occurrence for each of the components of the hydrogen refueling station. In this case, a higher first weight may be assigned as the frequency of accident occurrence is higher, and a lower first weight may be assigned as the frequency of accident occurrence is lower.

In addition, when a failure occurs for each of the components of the hydrogen refueling station, the analysis server 106 may pre-store information on the degree of impact due to the failure (that is, the degree of damage caused by the failure or the degree of performance degradation on the entire hydrogen refueling station due to the failure). The analysis server 106 may assign a second weight depending on the degree of failure impact for each of the components of the hydrogen refueling station. In this case, a higher second weight may be assigned as the degree of failure impact is higher, and a lower second weight may be assigned as the degree of failure impact is lower.

The analysis server 106 may calculate the risk degree based on the risk score, the first weight, and the second weight for each of the components of the hydrogen refueling station. The analysis server 106 may calculate the risk degree for each of the components of the hydrogen refueling station according to Equation 1 below,

Risk level=(α+β)·Score (Equation 1)

where α is the first weight,

β is the second weight, and

Score is the risk score.

The analysis server 106 may classify the risk degree level for each of the components of the hydrogen refueling station into a plurality of levels. For example, the analysis server 106 may classify the risk degree level into negligible, tolerable, undesirable, unacceptable, and the like according to the risk degree for each of the components of the hydrogen refueling station. The analysis server 106 may generate a separate alarm to the administrator when the risk degree level is above a certain level, for example, when the risk degree level is undesirable or unacceptable.

In addition, the analysis server 106 may calculate safety reliability of the hydrogen refueling station based on the risk degree for each of the components of the hydrogen refueling station. In an exemplary embodiment, the analysis server 106 may calculate the safety reliability of the hydrogen refueling station based on a value obtained by adding up all the risk degrees for the respective components of the corresponding hydrogen refueling station and then dividing the added value by the number of components of the hydrogen refueling station. That is, the analysis server 106 may calculate the safety reliability of the hydrogen refueling station by taking the inverse of an average risk degree of the components of the hydrogen refueling station.

According to the disclosed embodiments, by mounting the IoT sensor on each of the components of a hydrogen refueling station and collecting and analyzing sensing data from the IoT sensor, even when the administrator does not go to the site, it is possible to assess the risk degree for each of the components of the hydrogen refueling station by collecting and analyzing the sensing data from a distance, and to calculate the safety reliability of the hydrogen refueling station by putting the risk degrees together.

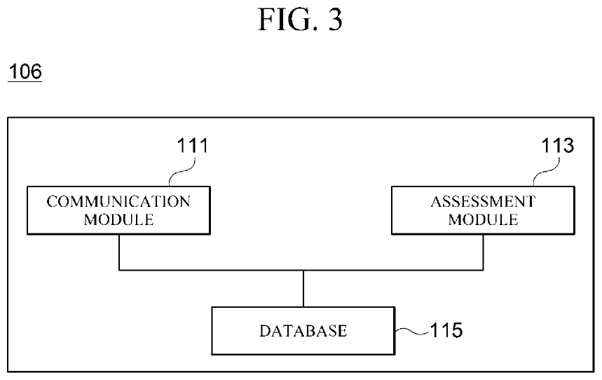

FIG. 3 is a block diagram showing a configuration of an analysis server according to one embodiment of the present disclosure.

Referring to FIG. 3, the analysis server 106 may include a communication module 111, an assessment module 113, and a database 115.

The communication module 111 may be communicatively connected to the data collection device 104 of each hydrogen refueling station. The communication module 111 may receive sensing data from each data collection device 104. The communication module 111 may generate an alarm to a preset administrator according to the risk degree for each of the components of the hydrogen refueling station calculated by the assessment module 113.

The assessment module 113 may calculate the risk degree for each of the components of the hydrogen refueling station based on the received sensing data. In this case, the assessment module 113 may use information on the frequency of accident occurrence and information on the degree of failure impact for each of the components of the hydrogen refueling station, which are stored in the database 115. In addition, the assessment module 113 may calculate the safety reliability of the hydrogen refueling station based on the risk degree for each of the components of the hydrogen refueling station.

The database 115 may store the information on the frequency of accident occurrence of each of the components constituting the hydrogen refueling station. The database 115 may store the information on the degree of failure impact for each the components of the hydrogen refueling station. Here, the analysis server 106 is described as including the database 115, but the present embodiment is not limited thereto, and the database 115 may be implemented as an external device separate from the analysis server 106.

In the present specification, a module may mean a functional and structural combination of hardware for carrying out the technical idea of the present disclosure and software for driving the hardware. For example, the “module” may mean a logical unit of a predetermined code and a hardware resource for executing the predetermined code, and does not necessarily mean physically connected code or a single type of hardware.

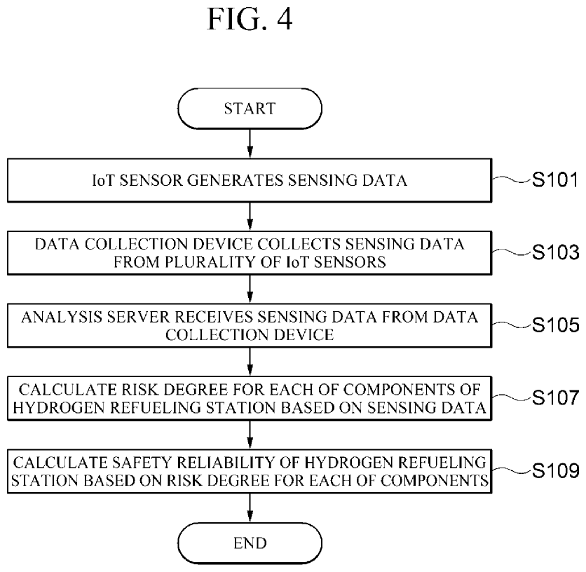

FIG. 4 is a flowchart illustrating a monitoring method for a hydrogen refueling station according to one embodiment of the present disclosure. In the illustrated flowchart, the method is divided into a plurality of steps; however, at least some of the steps may be performed in a different order, performed together in combination with other steps, omitted, performed in subdivided steps, or performed by adding one or more steps not illustrated.

Referring to FIG. 4, an IoT sensor 102 mounted on a component of the hydrogen refueling station may generate sensing data by measuring preset monitoring elements (S101).

Next, the data collection device 104 may collect sensing data from the plurality of IoT sensors 102 mounted on respective components of the hydrogen refueling station (S103).

Next, the analysis server 106 may receive sensing data about the hydrogen refueling station from the data collection device 104 (S105).

Next, the analysis server 106 may calculate a risk degree for each of the components of each hydrogen refueling station based on identification information and the measured values regarding the components of the hydrogen refueling station included in the sensing data (S107).

Next, the analysis server 106 may calculate safety reliability of the hydrogen refueling station based on the risk degree for each of the components of the hydrogen refueling station (S109).

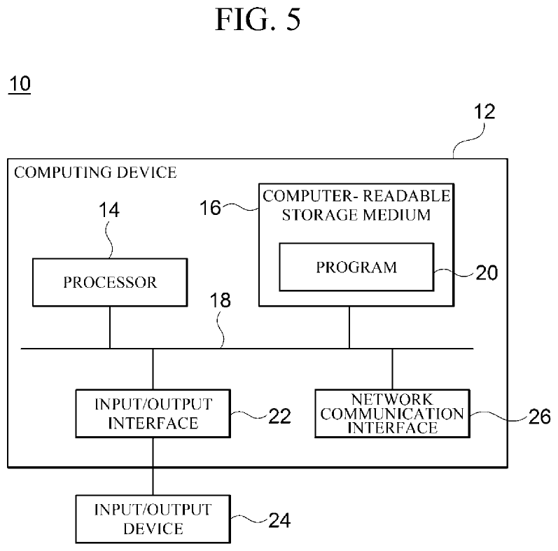

FIG. 5 is a block diagram exemplarily illustrating a computing environment 10 that includes a computing device suitable for use in exemplary embodiments. In the illustrated embodiment, each component may have a different function and capability in addition to those described below, and additional components may be included in addition to those described below.

The illustrated computing environment 10 includes a computing device 12. In an embodiment, the computing device 12 may be the data collection device 104. The computing device 12 may be the analysis server 106.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In one embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to a computing device 12 as a separate device distinct from the computing device 12.

According to the disclosed embodiments, by mounting an IoT sensor on each of components of a hydrogen refueling station and collecting and analyzing sensing data from the IoT sensor, even when an administrator does not go to a site, it is possible to assess a risk degree for each of the components of the hydrogen refueling station by collecting and analyzing the sensing data from a distance, and to calculate safety reliability of the hydrogen refueling station by putting the risk degrees together.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. A monitoring system for a hydrogen refueling station, the monitoring system comprising:
an Internet of things (IoT) sensor mounted on each of components of the hydrogen refueling station and configured to generate sensing data by measuring preset monitoring elements; and
an analysis server configured to obtain the sensing data and monitor a state of the hydrogen refueling station based on the obtained sensing data.

2. The monitoring system of claim 1, wherein the IoT sensor operates in a measurement mode for a preset time in a preset period and operates in a sleep mode at other times.

3. The monitoring system of claim 2, wherein the sensing data includes identification information and measured values for the monitoring elements regarding a component of the hydrogen refueling station on which a corresponding IoT sensor is mounted.

4. The monitoring system of claim 3, wherein the analysis server calculates a risk degree for each of the components of the hydrogen refueling station based on the identification information and the measured values for the monitoring elements regarding the component of the hydrogen refueling station.

5. The monitoring system of claim 4, wherein the analysis server assigns a risk score according to the number of times a measured value for each of the monitoring elements exceeds a preset reference value for each of the components.

6. The monitoring system of claim 5, wherein the analysis server assigns a first weight depending on a pre-stored frequency of accident occurrence and assigns a second weight depending on a pre-stored degree of failure impact, for each of the components.

7. The monitoring system of claim 6, wherein the analysis server assigns a higher first weight as the frequency of accident occurrence is higher and assigns a higher second weight as the degree of failure impact is higher.

8. The monitoring system of claim 7, wherein the analysis server calculates the risk degree for each of the components according to the following equation based on the risk score, the first weight, and the second weight,
(Equation)
Risk level=(α+β)·Score
where α is the first weight,
β is the second weight, and
Score is the risk score.

9. The monitoring system of claim 8, wherein the analysis server calculates safety reliability of the hydrogen refueling station by taking an inverse of a value obtained by adding up the risk degree for each of the components of the hydrogen refueling station and then dividing an added result by the number of the components of the hydrogen refueling station.

10. A monitoring method for a hydrogen refueling station that is performed in a computing device including one or more processors and a memory storing one or more programs executed by the one or more processors, the monitoring method comprising:
obtaining sensing data from an IoT sensor mounted on each of components of the hydrogen refueling station and configured to generate the sensing data by measuring preset monitoring elements; and
monitoring a state of the hydrogen refueling station based on the obtained sensing data.

11. The monitoring method of claim 10, wherein the IoT sensor is provided to operate in a measurement mode for a preset time in a preset period and operate in a sleep mode at other times.

12. The monitoring method of claim 11, wherein the sensing data includes identification information and measured values for the monitoring elements regarding a component of the hydrogen refueling station on which a corresponding IoT sensor is mounted.

13. The monitoring method of claim 12, wherein the monitoring includes calculating a risk degree for each of the components of the hydrogen refueling station based on the identification information and the measured values for the monitoring elements regarding the component of the hydrogen refueling station.

14. The monitoring method of claim 13, wherein the calculating of the risk degree includes assigning a risk score according to the number of times a measured value for each of the monitoring elements exceeds a preset reference value for each of the components.

15. The monitoring method of claim 14, wherein the calculating of the risk degree includes:
assigning a first weight depending on a pre-stored frequency of accident occurrence for each of the components; and
assigning a second weight depending on a pre-stored degree of failure impact for each of the components.

16. The monitoring method of claim 15, wherein the calculating of the risk degree includes:
assigning a higher first weight as the frequency of accident occurrence is higher and assigning a higher second weight as the degree of failure impact is higher.

17. The monitoring method of claim 16, wherein the calculating of the risk degree includes calculating the risk degree for each of the components according to the following equation based on the risk score, the first weight, and the second weight,
(Equation)
Risk level=(α+β)·Score
where α is the first weight,
β is the second weight, and
Score is the risk score.

18. The monitoring method of claim 17, wherein the monitoring further includes calculating safety reliability of the hydrogen refueling station by taking an inverse of a value obtained by adding up the risk degree for each of the components of the hydrogen refueling station and then dividing an added result by the number of the components of the hydrogen refueling station.

19. A computing device comprising:
one or more processors;
a memory; and
one or more programs,
wherein the one or more programs are configured to be stored in the memory and executed by the one or more processors, and
the one or more programs include:
a command for obtaining sensing data from an IoT sensor mounted on each of components of the hydrogen refueling station and configured to generate the sensing data by measuring preset monitoring elements; and
a command for monitoring a state of the hydrogen refueling station based on the obtained sensing data.
